(19) United States
(12) Patent Application Publication
(10) Pub. No.: US 2026/0015981 A1
(43) Pub. Date: Jan. 15, 2026

(54) MULTIFUNCTIONAL SWITCH BASE ASSEMBLY AND CONTROL METHOD THEREOF

(71) Applicant: ZHEJIANG CONSTANT POWER MACHINERY CO., LTD., Shaoxing (CN)

(72) Inventors: Xiangqing SHEN, Shaoxing (CN); Hongbo YUAN, Shaoxing (CN); Shaojia SHEN, Shaoxing (CN); Yang Meng, Shaoxing (CN); Zhou SHEN, Shaoxing (CN)

(73) Assignee: ZHEJIANG CONSTANT POWER MACHINERY CO., LTD., Shaoxing (CN)

(21) Appl. No.: 19/336,481

(22) Filed: Sep. 22, 2025

(30) Foreign Application Priority Data
Sep. 27, 2024 (CN) 202411354884.0

(51) Int. Cl. F02D 19/06

(52) U.S. Cl. CPC F02D 19/0613; F02D 19/0623; F02D 19/0676

(57) ABSTRACT

The present disclosure provides a multifunctional switch base assembly and a control method thereof, solving problems such as safety of switching between fuel and gas. The multifunctional switch base assembly comprises a switch base, where a switch knob as well as a gas switch assembly and an oil line switch assembly which are controlled by the switch knob to turn on or off are mounted on the switch base, the gas switch assembly and the oil line switch assembly are connected to a control module, and the control module is connected to a storage battery and an ignition coil. The present disclosure has the advantages of high safety, stable switching and the like.

### TECHNICAL FIELD

The present disclosure belongs to the technical field of fuel switches, and particularly relates to a multifunctional switch base assembly and a control method thereof.

### BACKGROUND

The task of a fuel supply system is to prepare a certain amount and concentration of combustible mixture according to the requirements of an engine under various operating conditions, deliver to a cylinder, and ignite the combustible mixture near the end of compression so that it expands and performs work. Finally, the supply system should also discharge a combustion product, namely exhaust gas, into the atmosphere. One of the keys to dual-fuel technology is the control of switching between oil and gas. A fuel switch is precisely used to achieve switching between fuels in an automatic or manual manner, and its quality is also related to the overall performance of a device. Currently, a generator set commonly used with two types of fuels, namely, gas (liquefied petroleum gas or natural gas) and liquid (such as gasoline.), generally includes a switch base, a valve body, and a knob. By manually operating the knob, the supply of one type of fuel can be cut off while the supply of the other type of fuel is activated, thereby achieving switching between the two types of fuels. However, in actual use, a simple mechanical control of the valve body for fuel switching has certain shortcomings in terms of safety and convenience of user operation.

To overcome the shortcomings of the prior art, long-term exploration has been conducted, and various solutions have been proposed. For example, a Chinese patent document discloses a three-fuel changeover switch (Publication No.: 202222025966.3), including a housing, a valve core, a changeover switch mounting plate, and a rotating handle. A lower end of the valve core is inserted into the housing, the changeover switch mounting plate is mounted on the top surface of the housing, and the upper end of the valve core passes upwards through the changeover switch mounting plate and is provided with the rotating handle capable of driving the valve core to rotate. The housing is provided with an oil inlet nozzle and an oil outlet nozzle for flue flow, and an air inlet pipe and an air outlet pipe for gas flow. The valve core is provided with a flow guide groove for connecting the oil inlet nozzle and the oil outlet nozzle, and an LNG fuel hole and an NG fuel hole for connecting the air inlet pipe and the air outlet pipe. The above solution solves the problem of switching between liquefied petroleum gas and liquefied natural gas to a certain extent However, this solution still has many shortcomings, such as the inability to guarantee the safety of switching between fuel and gas.

### SUMMARY

Aiming at the above problems, an objective of the present disclosure is to provide a multifunctional switch base assembly with a reasonable design and high safety is use.

Aiming at the above problems, another objective of the present disclosure is to provide a control method for the multifunctional switch base assembly with flexible control.

To achieve the above objectives, the present disclosure adopts the following technical solution: a multifunctional switch base assembly includes a switch base, where a switch knob as well as a gas switch assembly and an oil line switch assembly which are controlled by the switch knob to turn on or off are mounted on the switch base, the gas switch assembly and the oil line switch assembly are connected to a control module, and the control module is connected to a storage battery and an ignition coil.

In the above multifunctional switch base assembly, the gas switch assembly includes a second microswitch connected to the control module, and the second microswitch is connected to a gas solenoid valve and controls the opening of a gas channel.

In the above multifunctional switch base assembly, the control module is connected to a third microswitch, and the third microswitch controls the closing of both the gas channel and a fuel channel.

In the above multifunctional switch base assembly, the oil line switch assembly includes a first microswitch and a carburetor solenoid valve which are connected to the control module, the switch base is connected to an oil switch, the first microswitch controls the opening of the carburetor solenoid valve, and the oil switch controls the opening or closing of the fuel channel.

In the above multifunctional switch base assembly, the switch base is provided with a switching cavity for rotational assembly of the switch knob. The first microswitch, the second microswitch and the third microswitch are selectively triggered as the switch knob, and the oil switch is mounted at the center of the switching cavity and is turned on or off as the switch knob rotates.

In the above multifunctional switch base assembly, a limiting groove is arranged at the bottom of the switching cavity, and a limiting steel ball is mounted in the limiting groove via a limiting spring and can be pressed by and engaged with the switch knob in a limiting manner. A ball plunger is movably mounted on a side of the switch knob, a clamping groove for insertion of the ball plunger in a limiting manner is arranged on an inner side of the switching cavity, and a position where the ball plunger is inserted into and limited by the clamping groove corresponds to the second microswitch and the first microswitch.

In the above multifunctional switch base assembly, a timing reset assembly is arranged between the switch knob and the switch base and includes a reset motor mounted in the switch base, where an output end of the reset motor faces upwards and is connected to a reset gear set. A lower end of the switch knob is provided with a reset gear ring engaged with the reset gear set in a driving manner, the reset motor is connected to the control module, and a timing switch connected to the control module is mounted on the switch base. A first guide surface arranged obliquely in a radial direction relative to the switch base is arranged on an inner side of the switch base, the ball plunger is provided with a limiting hook extending into the interior of the switch knob, and the limiting hook is pressed against the first guide surface. A second guide surface arranged obliquely is provided on the reset gear ring, and the limiting steel ball is pressed against the second guiding surface.

A control method for a multifunctional switch base assembly includes the following steps:
S1: triggering the second microswitch, to open the gas solenoid valve and the gas channel, when the switch knob is at a first position relative to the switch base;
S2: triggering the third microswitch to close the gas solenoid valve, the oil switch, the gas channel and the fuel channel, when the switch knob rotates to a second position relative to the switch base;
S3: closing the oil switch, and opening the fuel channel, when the switch knob rotates to a third position relative to the switch base; and
S4: triggering the first microswitch to open the carburetor solenoid valve and the fuel channel, when the switch knob rotates to a fourth position relative to the switch base.

In the above control method for the multifunctional switch base assembly, in steps S1 and S4, the ignition coil is activated to ignite the gas or fuel.

In the above control method for the multifunctional switch base assembly, in step S2, the storage battery is disconnected from the control module, and a circuit connected to the control module is cut off.

In the above control method for the multifunctional switch base assembly, in step S3, the carburetor solenoid valve is opened.

In the above control method for the multifunctional switch base assembly, in steps S2 and S3, by pressing the timing switch, the reset motor is activated to drive the switch knob to rotate automatically, and the control module controls the switch knob to switch with a delay between the second position and the third position.

Compared with the prior art, the advantages of the present disclosure are as follows: the oil switch adopts mechanical control for on-off operations, while the gas and fuel channels are controlled by solenoid valves for on-off operations. Compared with conventional mechanically controlled valve bodies, the safety of fuel switching and the convenience of user operation are improved. The switch base assembly is provided with a built-in limiting structure, which enhances the stability of the switch knob in rotational limiting, and ensure the normal on-off switching points. An additional fuel-off position is added, and only the oil switch is closed without cutting off the power supply to the fuel solenoid valve, thereby reducing the residual fuel inside the carburetor and eliminating the need for manual oil drainage. An additional position is added to fully close all channels between fuel and gas switching, preventing safety issues caused by arbitrary switching between the two types of fuels.

### BRIEF DESCRIPTION OF THE DRAWINGS

FIG. 1 is a schematic structural diagram of the present disclosure.

FIG. 2 is a schematic structural diagram of a switch base of the present disclosure.

FIG. 3 is an exploded structural diagram of the present disclosure.

FIG. 4 is a control principle diagram of the present disclosure.

FIG. 5 is another schematic structural diagram of a switch base of the present disclosure.

FIG. 6 is a schematic structural diagram of a switch knob of the present disclosure.

Reference numerals in the figures: switch base 1, switching cavity 11, limiting groove 12, limiting spring 13, limiting steel ball 14, ball plunger 15, clamping groove 16, switch knob 2, gas switch assembly 3, second microswitch 31, gas solenoid valve 32, oil circuit switch assembly 4, first microswitch 41, carburetor solenoid valve 42, oil switch 43, control module 5, storage battery 51, ignition coil 52, third microswitch 53, timing reset assembly 6, reset motor 61, reset gear set 62, reset gear ring 63, timing switch 64, first guide surface 65, limiting hook 66, second guide surface 67.

### DETAILED DESCRIPTION OF THE EMBODIMENTS

The present disclosure will be further described in detail below with reference to the accompanying drawings and specific embodiments.

### Embodiment 1

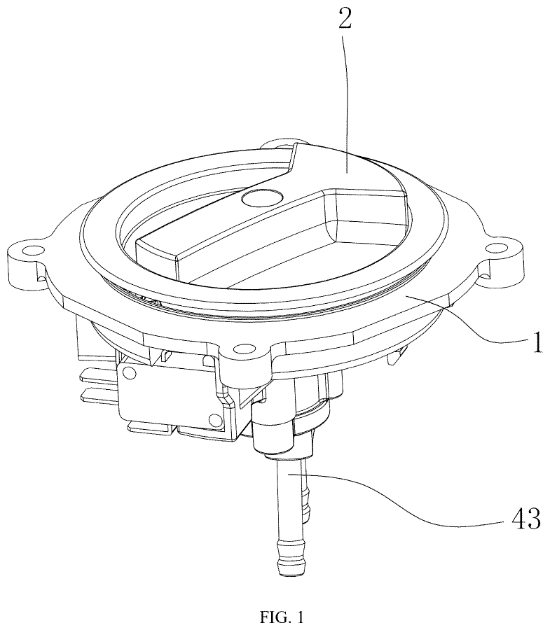

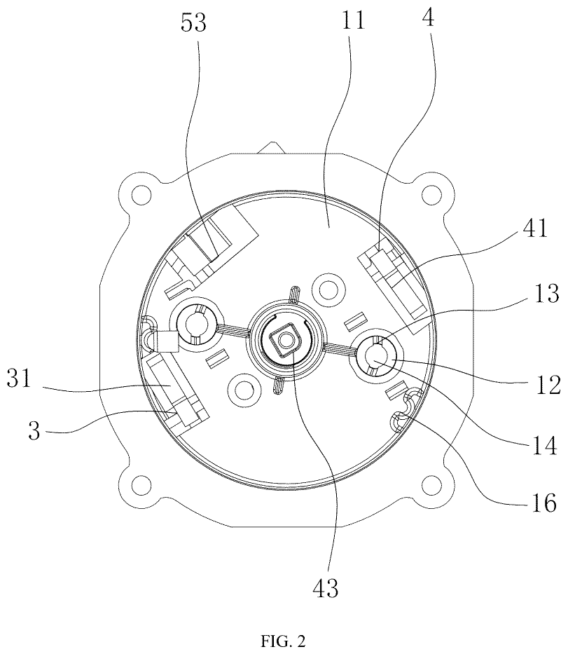

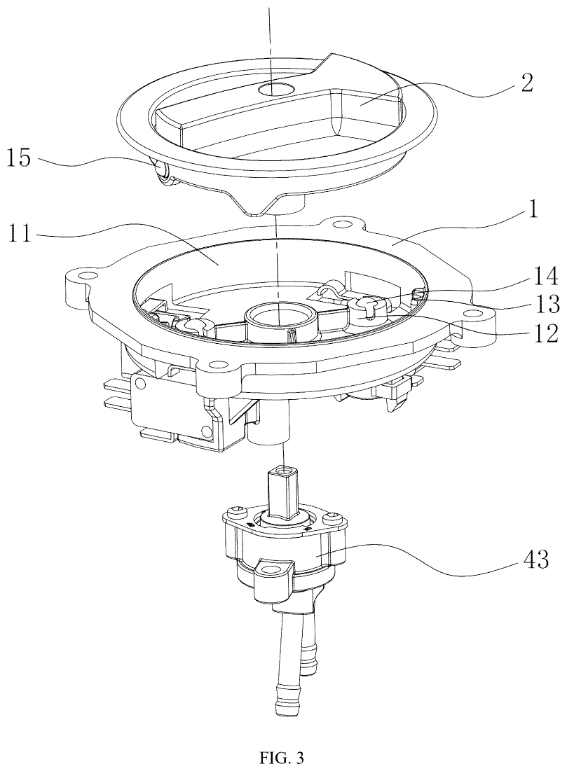

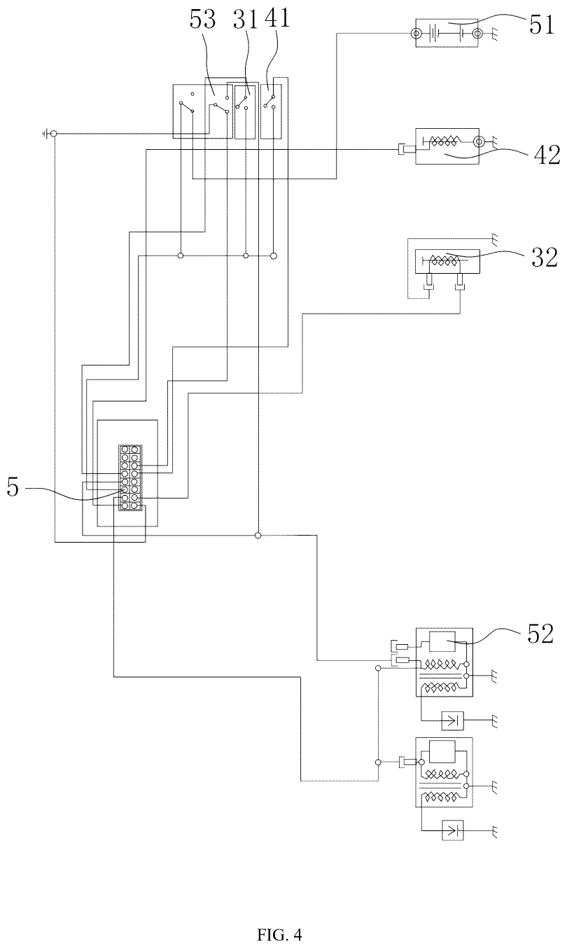

As shown in FIGS. 1 to 4, a multifunctional switch base assembly includes a switch base 1 matched with an automobile fuel system or a generator set. Different from the existing mechanical fuel switching system, in this embodiment, a switch knob 2 as well as a gas switch assembly 3 and an oil line switch assembly 4 which are controlled by the switch knob 2 to turn on or off are mounted on the switch base 1. The gas switch assembly 3 is controlled by a circuit, and the oil line switch assembly 4 is controlled by a combination of mechanical control and circuit control. The gas switch assembly 3 and the oil line switch assembly 4 are connected to a control module 5, and the control module 5 is connected to a storage battery 51 and an ignition coil 52. The control module 5 receives a circuit signal and controls the opening and closing of corresponding solenoid valves. The storage battery 51 supplies power to the control module 5 and other circuits, and the ignition coil 52 cooperates with a corresponding transformer to ignite the fuel.

Specifically, the gas switch assembly 3 is controlled by a circuit, and specifically includes a second microswitch 31 connected to the control module 5. The second microswitch 31 is connected to the gas solenoid valve 32 and controls the opening of the gas channel. The gas solenoid valve 32 remains closed under normal conditions, and is activated to open when the second microswitch 31 is triggered.

In further detail, to realize the on-off control of the control module 5 and the entire circuit system, the control module 5 is connected to a third microswitch 53, and the third microswitch 53 controls the closing of both the gas channel and the fuel channel. Under normal conditions, the control module 5 remains connected to the storage battery 51 for power supply. When the third microswitch 53 is triggered, the control module 5 is disconnected from the storage battery 51, and the entire circuit system and the controlled solenoid valves are shut off.

Further, different from the existing mechanical oil circuit control system, the oil line switch assembly 4 includes a first microswitch 41 and a carburetor solenoid valve 42 that are connected to the control module 5. The switch base 1 is connected to an oil switch 43, the first microswitch 41 controls the opening of the carburetor solenoid valve 42. and the oil switch 43 controls the opening or closing of the fuel channel. The switch knob 2 rotates to drive the oil switch 43 to open or close. The oil switch 43 is connected to an external oil supply pipeline, and the carburetor solenoid valve 42 controls the opening and closing of an internal oil line. The oil switch 43 is provided with a pin shaft that is inserted into the switch knob 2 to control the rotation of in internal valve seat.

In addition, the switch base 1 is entirely disc-shaped and is provided with a switching cavity 11 for the rotational assembly of the switch knob 2. A ridge-shaped twisting handle is reserved at the top of the switch knob 2, and the rotational range of the switch knob 2 is usually controlled within 180° to 270°. The first microswitch 41, the second microswitch 31, and the third microswitch 53 are selectively triggered as the switch knob 2 rotates. The oil switch 43 is mounted at the center of the switching cavity 11 and is turned on or off as the switch knob 2 rotates. Each rotation angle of the switch knob 2 is a fixed angle of 90°, 45°, 60°, 30°, or the like.

In addition, to enhance the stability of the switch knob 2 in rotational limiting and ensure that the switch knob 2 is locked in place after rotating to a specified position, a limiting groove 12 is arranged at the bottom of the switching cavity 11. A limiting steel ball 14 is mounted in the limiting groove 12 via a limiting spring 13 and can be pressed against and engaged with the switch knob 2 in a limiting manner. A ball plunger 15 is movably mounted on a side of the switch knob 2, and a clamping groove 16 for insertion of the ball plunger 15 in a limiting manner is arranged on an inner side of the switching cavity 11. A position where the ball plunger 15 is inserted into and limited by the clamping groove 16 corresponds to the second microswitch 31 and the first microswitch 41. Both the ball plunger 15 and the limiting steel ball 14 adopt a sliding telescopic structure, and are embedded into corresponding grooves by a pressure force for limiting. When the switch knob 2 rotates to a specified angle, a detent action occurs, and at this time, the switch knob 2 is limited at the specified position. The internal first microswitch 41, second microswitch 31, or third microswitch 53 is pressed and sends a control signal to the control module 5.

### Embodiment 2

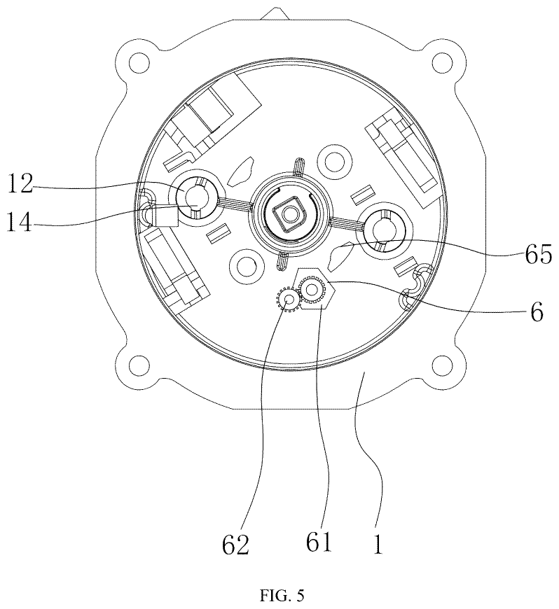

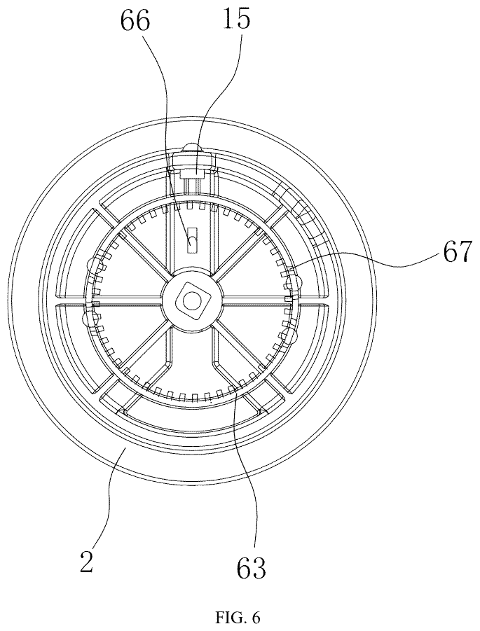

As shown in FIGS. 5-6, the structure, principle, and specific implementation steps of this embodiment are similar to those of Embodiment 1. The difference lies in that a timing reset assembly 6 is arranged between the switch knob 2 and the switch base 1 to realize a delayed response of the gas switch assembly 3 and the oil line switch assembly 4. In this embodiment, the control module 5 controls the response time, and a mechanical driving method is adopted to realize the transmission of the switch knob 2.

In this embodiment, the timing reset component 6 is concentrated between the switch base 1 and the switch knob 2, and includes a reset motor 61 mounted in the switch base 1. An output end of the reset motor 61 faces upwards and is connected to a reset gear set 62, and a lower end of the switch knob 2 is provided with a reset gear ring 63 engaged with the reset gear set 62 in a driving manner. The reset motor 61 is connected to the control module 5, and a timing switch 64 connected to the control module 5 is mounted on the switch base 1. The timing switch 64 is manually pressed to trigger, and the control module 5 receives a control signal and controls the reset motor 61 to rotate and drive the switch knob 2 to rotate by a fixed angle.

Since the limiting structure is arranged between the switch knob 2 and the switch base 1, a first guide surface 65 arranged obliquely in a radial direction relative to the switch base 1 is arranged on an inner side of the switch base 163, to ensure the normal disengagement of the limiting steel ball 14 and the ball plunger 15 from their positions. The ball plunger 15 is provided with a limiting hook 66 extending into the interior of the switch knob 2, and the limiting hook 66 is pressed against the first guide surface 65. A second guide surface 67 arranged obliquely is provided on the reset gear ring 63, and the limiting steel ball 14 is pressed against the second guide surface 67. The first guide surface 65 and the second guide surface 67 guide the limiting steel ball 14 and the ball plunger 15 to slide smoothly and diagonally, reducing the resistance to disengaging them from their positions.

In a control method for a multifunctional switch base assembly, the gas switch assembly 3 and the oil line switch assembly 4 are controlled according to the rotation angle of the switch knob 2. The switch knob 2 can rotate counterclockwise or clockwise. The following steps describe clockwise rotation, and the steps can also be reversed for counterclockwise rotation to achieve state switching:
S1: in an initial state, the switch knob 2 is at a first position relative to the switch base 1, the second microswitch 31 is triggered under pressure, the gas solenoid valve 32 and opening the gas channel are opened, and both the oil switch 43 and the carburetor solenoid valve 42 are in a closed state which corresponds to a signal gas supply state;
S2: when needing to switching to a fuel supply state, the switch knob 2 first rotates clockwise to a second position relative to the switch base 1, the third microswitch 53 is triggered under pressure, the gas solenoid valve 32 and the oil switch 43 are closed, the gas channel and the fuel channel are closed, and the control module 5 is also in a power-off state;
S3: the switch knob 2 rotates clockwise to a third position relative to the switch base 1, the oil switch 43 is closed, but the fuel channel is opened, and in this state, the fuel in the carburetor is mainly consumed fully; and
S4: the switch knob 2 rotates to a fourth position relative to the switch base 1, the first microswitch 41 is triggered, the carburetor solenoid valve 42 the fuel channel are opened, and the gas solenoid valve 32 is in the closed state which corresponds to a single fuel supply state.

In addition, in steps S1 and S4, the ignition coil 52 is activated to ignite the gas or fuel. The ignition coil 52 is energized synchronously with the gas solenoid valve 32 or the carburetor solenoid valve 42, thereby igniting the fuel to activate a power system.

Meanwhile, to enhance safety in step S2, the storage battery 51 is disconnected from the control module 5, and a circuit connected to the control module 5 is cut off. This step mainly ensures that the entire circuit is shut down, thereby guaranteeing the power-off during the switching process between gas and fuel, and preventing the fuel from remaining in an ignited state.

Notably, in step S3, the carburetor solenoid valve 42 is opened while the oil switch 43 is closed, allowing residual fuel to flow in an internal fuel pipeline and the fuel in the carburetor to be fully consumed without the need for manual oil drainage. Compared with a conventional three-position fuel switching system, this embodiment adopts a four-position design. The position corresponding to step S3 avoids crossover during the switching between fuel and gas, and prevents safety hazards caused by fuel backfire inside the pipeline.

In steps S2 and S3, the timing switch 64 is pressed, the reset motor 61 is activated to drive the switch knob 2 to rotate automatically. The control module 5 controls the switch knob 2 to switch with a delay between the second position and the third position. Under normal conditions, when the switch knob 2 switches from the third position to the second position, its response time is controlled within 2-3 seconds, ensuring that the fuel in the carburetor is fully consumed.

In summary, the principle of this embodiment lies in that the switch base 1 and the switch knob 2 improve the limiting method of the gas switch assembly 3 and the oil line switch assembly 4 in a full OFF state, thereby avoiding instability in limiting that could prevent proper power-off and shutdown. An additional fuel-off state is added, and only the oil switch 43 is closed without cutting off the power supply to the carburetor solenoid valve 42, allowing a user to fully consume the fuel in the carburetor in this state without the need for manual oil drainage. Limiting is performed in the gas ON and gasoline ON states, requiring the switch to pass through the OFF position before switching between these two states, thereby preventing safety hazards caused by arbitrary switching between two types of fuels.

The specific embodiments described herein are merely illustrative of the spirit of the present disclosure. Those skilled in the technical field to which the present disclosure pertains may make various modifications, additions, or substitutions to the specific embodiments described in similar manners, without departing from the spirit of the present disclosure or exceeding the scope defined by the appended claims.

Although this specification frequently uses terms such as the switch base 1, switching cavity 11, limiting groove 12, limiting spring 13, limiting steel ball 14, ball plunger 15, clamping groove 16, switch knob 2, gas switch assembly 3, second microswitch 31, gas solenoid valve 32, oil line switch assembly 4, first microswitch 41, carburetor solenoid valve 42, oil switch 43, control module 5, storage battery 51, ignition coil 52, and third micro switch 53, it does not exclude the possibility of using other terms. These terms are merely used to describe and explain the essence of the present disclosure more conveniently, and interpreting these terms as any kind of additional limitation is contrary to the spirit of the present disclosure.

What is claimed is:

1. A multifunctional switch base assembly, comprising a switch base (1), wherein a switch knob (2) as well as a gas switch assembly (3) and an oil line switch assembly (4) which are controlled by the switch knob (2) to turn on or off are mounted on the switch base (1); the gas switch assembly (3) and the oil line switch assembly (4) are connected to a control module (5), and the control module (5) is connected to a storage battery (51) and an ignition coil (52); the gas switch assembly (3) comprises a second microswitch (31) connected to the control module (5), and the second microswitch (31) is connected to a gas solenoid valve (32) and controls the opening of a gas channel; the control module (5) is connected to a third microswitch (53), and the third microswitch (53) controls the closing of both the gas channel and a fuel channel; and the oil line switch assembly (4) comprises a first microswitch (41) and a carburetor solenoid valve (42) which are connected to the control module (5), the switch base (1) is connected to an oil switch (43), the first microswitch (41) controls the opening of the carburetor solenoid valve (42), and the oil switch (43) controls the opening or closing of the fuel channel.

2. The multifunctional switch base assembly of claim 1, wherein the switch base (1) is provided with a switching cavity (11) for rotational assembly of the switch knob (2), the first microswitch (41), the second microswitch (31) and the third microswitch (53) are selectively triggered as the switch knob (2) rotates, and the oil switch (43) is mounted at the center of the switching cavity (11) and is turned on or off as the switch knob (2) rotates.

3. The multifunctional switch base assembly of claim 2, wherein a limiting groove (12) is arranged at the bottom of the switching cavity (11), a limiting steel ball (14) is mounted in the limiting groove (12) via a limiting spring (13) and can be pressed against and engaged with the switch knob (2) for limiting; and a ball plunger (15) is movably mounted on a side of the switch knob (2), a clamping groove (16) for insertion of the ball plunger (15) in a limiting manner is arranged on an inner side of the switching cavity (11), and a position where the ball plunger (15) is inserted into and limited by the clamping groove (16) corresponds to the second microswitch (31) and the first microswitch (41).

4. The multifunctional switch base assembly of claim 3, wherein a timing reset assembly (6) is arranged between the switch knob (2) and the switch base (1); the timing reset assembly (6) comprises a reset motor (61) mounted in the switch base (1), an output end of the reset motor (61) faces upwards and is connected to a reset gear set (62), a lower end of the switch knob (2) is provided with a reset gear ring (63) meshed with the reset gear set (62) in a driving manner, the reset motor (61) is connected to the control module (5), and a timing switch (64) connected to the control module (5) is mounted on the switch base (1); a first guide surface (65) arranged obliquely in a radial direction relative to the switch base (1) is arranged on an inner side of the switch base (1), the ball plunger (15) is provided with a limiting hook (66) extending into the interior of the switch knob (2), and the limiting hook (66) is pressed against the first guide surface (65); and a second guide surface (67) arranged obliquely is provided on the reset gear ring (63), and the limiting steel ball (14) is pressed against the second guiding surface (67).

5. A control method for the multifunctional switch base assembly of claim 1, comprising the following steps:
S1: triggering the second microswitch (31) to open the gas solenoid valve (32) and the gas channel, when the switch knob (2) is at a first position relative to the switch base (1);
S2: triggering the third microswitch (53) to close the gas solenoid valve (32), the oil switch (43), the gas channel and the fuel channel, when the switch knob (2) rotates to a second position relative to the switch base (1);
S3: closing the oil switch (43), and opening the fuel channel, when the switch knob (2) rotates to a third position relative to the switch base (1); and
S4: triggering the first microswitch (41) to open the carburetor solenoid valve (42) and the fuel channel, when the switch knob (2) rotates to a fourth position relative to the switch base (1).

6. The control method for the multifunctional switch base assembly of claim 5, wherein in steps S1 and S4, the ignition coil (52) is activated to ignite the gas or fuel;
in step S2, the storage battery (51) is disconnected from the control module (5), and a circuit connected to the control module (5) is cut off; and in step S3, the carburetor solenoid valve (42) is opened.

7. The control method for the multifunctional switch base assembly of claim 5, wherein by pressing the timing switch (64) in steps S2 and S3, the reset motor (61) is activated to drive the switch knob (2) to rotate automatically, and the control module (5) controls the switch knob (2) to switch with a delay between the second position and the third position.
